(19) United States
(12) Patent Application Publication
(10) Pub. No.: US 2010/0247897 A1
(43) Pub. Date: Sep. 30, 2010

(54) MONOLITHIC POLYMER CROSSLINKED COMPOSITE MATERIALS AND METHODS OF MAKING

(76) Inventors: Nicholas Leventis, Rolla, MO (US); Sudhir Mulik, Rolla, MO (US); Chariklia Sotiriou-Leventis, Rolla, MO (US)

Correspondence Address: CARR LLP, 670 FOUNDERS SQUARE, 900 JACKSON STREET, DALLAS, TX, 75202, US

(21) Appl. No.: 12/676,126

(22) PCT Filed: Sep. 5, 2008
(86) PCT No.: PCT/US08/75463

§ 371 Date: Jun. 8, 2010

Related U.S. Application Data
(60) Provisional application No. 60/970,741, filed on Sep. 7, 2007.
(60) Provisional application No. 60/970,742, filed on Sep. 7, 2007.
(60) Provisional application No. 61/091,286, filed on Aug. 22, 2008.

(30) Foreign Application Priority Data
Aug. 22, 2008 (US) PCT/US2008/074081

(51) Int. Cl. B32B 3/26; B05D 3/10; B05D 3/02

(52) U.S. Cl. 428/319.3; 427/302; 427/385.5; 977/773

(57) ABSTRACT

A bidentate free radical crosslinking initiator binds chemically to silica and silica rich surfaces and enables the free radical based polymerization of various materials such as styrene, divinylbenzene and methylmethacrylate onto silica and silica rich surfaces. When used in connection with aerogels, the resultant crosslinked aerogels exhibit greatly increased strength with only nominal increase in density.

### STATEMENT OF RELATED APPLICATIONS

This application relates to, and claims the benefit of the filing date of: co-pending U.S. provisional patent application Ser. No. 60/970,741 entitled POLYMER NANO-ENCAPSULATED ACID-CATALYZED SOL-GEL MESOPOROUS SILICA MONOLITHS, filed Sep. 7, 2007; co-pending U.S. provisional patent application Ser. No. 60/970,742 entitled BIDENTATE GEL CROSSLINKERS MATERIALS AND METHODS FOR MAKING AND USING THE SAME, filed Sep. 7, 2007; co-pending U.S. provisional patent application Ser. No. 61/091,286 entitled PRE-FORMED ASSEMBLIES OF SOLGEL-DERIVED NANOPARTICLES AS 3-D SCAFFOLDS FOR COMPOSITES AND AEROGELS, filed Aug. 22, 2008; and co-pending international patent application no. PCT/US08/74081 entitled PRE-FORMED ASSEMBLIES OF SOLGEL-DERIVED NANOPARTICLES AS 3-D SCAFFOLDS FOR COMPOSITES AND AEROGELS, filed Aug. 22, 2008; the entire contents of which are incorporated herein by reference for all purposes.

### STATEMENT OF GOVERNMENT RIGHTS

Development of the present technology was funded at least in part by the National Science Foundation of the United States Federal Government under Contract Nos. NSF CMMI 0653919 and NSF CHE 0809562.

### BACKGROUND

1. Field of the Technology

The technology relates generally to applying polymer coatings to surfaces. The technology has application in the polymer crosslinking of particles in gels, especially aerogels, and more particularly to the use of bidentate, free radical, crosslinking initiators to crosslink gels with polymers and the resulting high strength gel products.

2. Description of the Related Art

Quasi-stable, ultra-low density, three-dimensional assemblies of nanoparticles are referred to as aerogels. Aerogels are open-cell foams obtained from the supercritical fluid (SCF) drying of wet gels. Their large internal void space results in low dielectric constants, low thermal conductivities and high acoustic impedance. However, these materials are fragile and impractical for high load applications. The fragility problem has been addressed by casting a thin conformal polymer coating over substantially the entire internal porous surface of the nanostructure. That process is referred to as “crosslinking.” The coating chemically connects the skeletal nanoparticles making up the three dimensional assemblies by coating inter-particle necks and making these necks stronger and wider. When these coatings are conformal and do not significantly fill the void spaces between the nanoparticles, a significant percentage of internal void space of the aerogel is retained. Thus, while the flexural strength of a typical aerogel made up of structured three dimensional assemblies may increase significantly, the increase in aerogel density may be small in comparison.

Current preparation procedures for making crosslinked aerogels require several solvent exchange steps. There are also several chemistries involving nanoparticle surface modification for making core-shell structures. These methods span the entire range of processes. Free-radical initiators have received little attention as silica surface modifiers. Indeed, most examples appear limited to monodentate asymmetric peroxide and AIBN derivatives, which are attached to silica only at one end. Such monodentate free-radical initiators, upon homolytic cleavage, produce only one surface-bound free-radical and a second free-radical in solution. During this process, polymer forms from monomer-containing solution and that polymer then has to be removed. This polymer removal step introduces additional solvent exchange steps.

### SUMMARY

An exemplary embodiment provides a method of coating a surface. The method includes the steps of providing a surface having hydroxyl groups and exposing the surface to a bidentate free radical crosslinking initiator. The free radical crosslinking initiator has terminal ends each able to form a chemical bond with a hydroxyl group, and a backbone extending between the terminal ends. The backbone is able to cleave homolytically to produce a pair of cleaved ends, each cleaved end having a free radical. The method further includes the step of reacting a hydroxyl group of the surface with each of the terminal ends of the bidentate free radical crosslinking initiator; and cleaving the backbone of the bidentate free radical crosslinking initiator to produce a surface bound free radical at each cleaved end. Polymerization of a compound is initiated by the surface bound free radicals produced; and a polymer coating is formed on at least a portion of the surface.

A further exemplary embodiment provides a method of producing a monolithic product. The monolithic product includes an assembly of three dimensionally dispersed, polymer coated, nanoparticles. The method of producing includes the steps of providing a gel that has nanoparticles having surfaces to which are attached a bidentate free radical crosslinking initiator, and exposing the surfaces to a compound able to polymerize. Further, the method includes allowing the bidentate free radical crosslinking initiator to initiate polymerization of the compound onto the gel surfaces. In addition it includes the steps of forming a polymer coating on at least a portion of the surfaces; and drying into the monolithic product.

A yet further exemplary embodiment provides a monolithic product. The monolithic product has a three dimensional assembly of nanoparticles with void space between nanoparticles. The nanoparticles have surfaces comprising hydroxyl groups. Further, the monolithic product includes a polymer coating covering at least some of the surfaces of the nanoparticles and, in some instances, at least partially filling at least some of the void space between nanoparticles. The polymer coating formed by surface initiated polymerization of constituent monomers of the polymer at locations on nanoparticle surfaces that had been modified by reaction of the hydroxyl groups on the surfaces with a bidentate free radical crosslinking initiator. A variation of the embodiment may include silica nanoparticles. In addition, the exemplary embodiment of the monolithic product may have a density less than about 0.8 g/cc. Further, the exemplary embodiment of the monolithic product may have a specific energy absorption less than about 194 J/g. In addition, the polymer coating may be of polymerized olefin.

### BRIEF DESCRIPTION OF THE DRAWINGS

For a more complete understanding of the present invention and the advantages thereof, reference is now made to the following Detailed Description taken in conjunction with the accompanying drawings, in which:

FIG. 1 is an illustration of a generalized exemplary embodiment of a chemical formula of a bidentate free radical crosslinking initiator, of which Compound 1, prepared in the Examples, is a particular exemplary embodiment;

FIG. 2 is a schematic representation of a bidentate free radical crosslinking initiator bonded to a surface and initiating a reaction, while attached to the surface, in accordance with an exemplary embodiment;

FIG. 3 is a simplified illustration of Scheme 1, according to the Examples, of an exemplary embodiment of a process for the synthesis of an exemplary bidentate free radical crosslinking initiator;

FIG. 4 is an illustration of Scheme 2, according to the Examples, of an exemplary embodiment of a process for crosslinking silica aerogels;

FIG. 5 is an SEM of a silica aerogel cross-linked with polystyrene, in accordance with an exemplary embodiment;

FIG. 6 shows FTIR spectra of non-cross linked (native) silica aerogels, silica aerogels cross-linked with PMMA and of neat PMMA, in accordance with an exemplary embodiment;

FIG. 7 is a DSC of cross-linked silica aerogels with PMMA and polystyrene, in accordance with an exemplary embodiment;

FIG. 8 shows IR of PMMA and PS cross-linked silica-based aerogels, in accordance with an exemplary embodiment;

FIG. 9 shows CPMAS ¹³C-NMR of PMMA and PS cross-linked silica-based aerogels, in accordance with an exemplary embodiment;

FIG. 10 is a graph illustrating the changes in weight of three gels plotted as a function of temperature, in accordance with an exemplary embodiment. Thermogravimetric analysis (TGA) at 10° C. min⁻¹ in air of: (A) Compound 1 (see Examples) and native Si-1; (B) crosslinked samples of X-Si-1-PMMA and X-Si-1-PS at the densities shown. The total mass loss by Si-1 (˜20% w/w) correlates well with the 18:1 mol ratio of TMOS:1 used in the sol (see text). The total mass loss by X-Si-1-polymer also correlates well with the amount of polymer calculated by the density increase and monolith size decrease upon crosslinking;

FIG. 11 is an electron micrographic analysis of the surfaces of three different aerogels showing BET surface area and average pore diameter for each aerogel. One SEM shows a native aerogel with a density of 0.189 g cm⁻³. A second shows X-Silica-1-PS in having a density of 0.549 g cm³, accordance with an exemplary embodiment. A third shows X-Silica-1-PMMA with a density of 0.807 g cm⁻³, in accordance with an exemplary embodiment; and

FIG. 12 illustrates compression testing graphs of stress versus strain for PMMA monoliths in accordance with an exemplary embodiment. Top: Samples before compression, left two: X-Si-1-PMMA, ρ_{b}=0.66 g/cm³; right two: X-Si-1-PS, τ_{b}=0.46 g/cm³. Bottom: Samples after compression, left: X-Si-1-PMMA, compressed by 86% strain; right: X-Si-1-PS, compressed by 96% strain.

### DETAILED DESCRIPTION

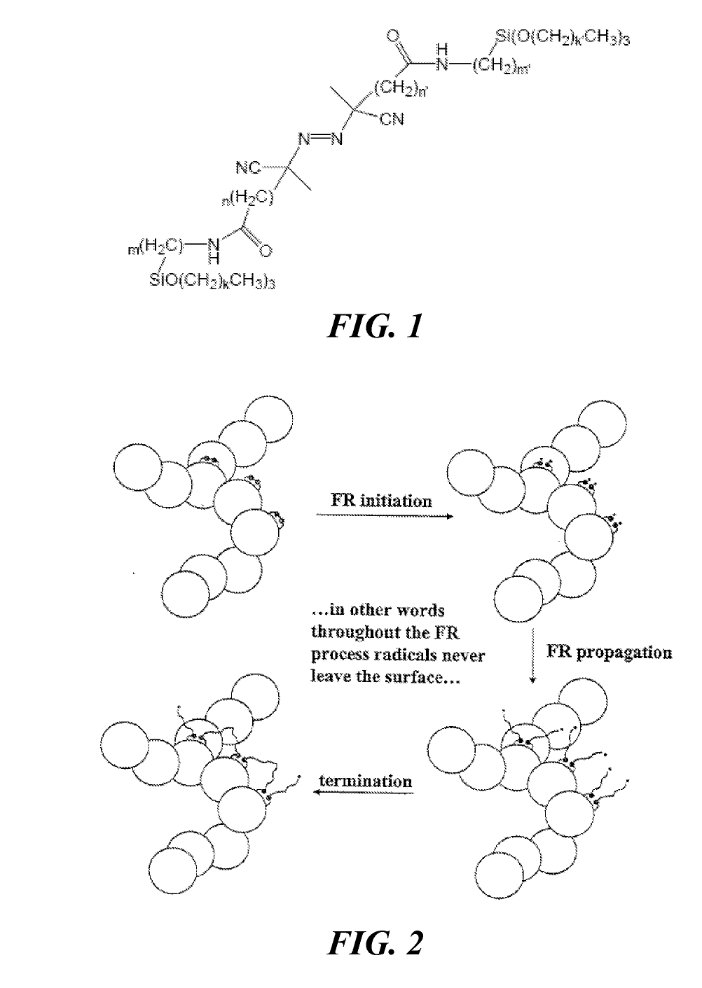

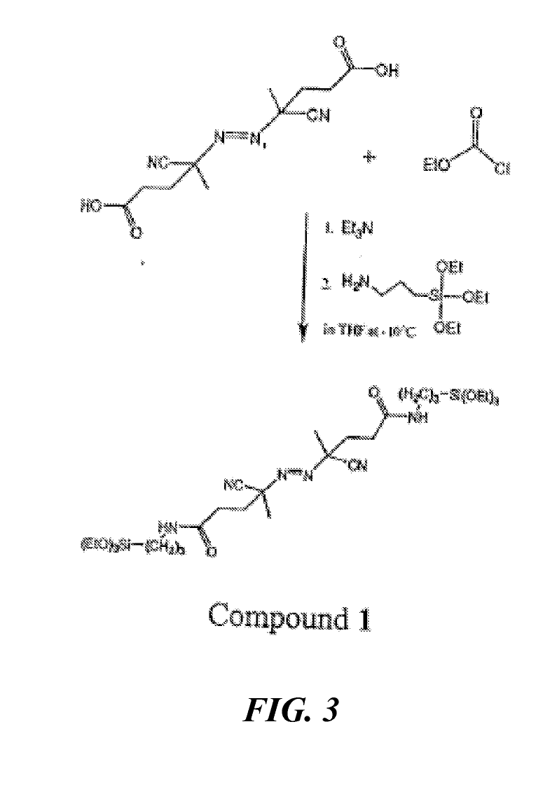

In an exemplary embodiment, the gelation process and the crosslinking process are deconvoluted by sing a free radical crosslinking process, and especially through use of a surface bound bidentate free radical polymerization initiator. By “deconvolute” is meant that the two processes are made compatible so that chemistry for each may coexist in a “single pot” without interference of chemistry of one process with the other process. An example of a bidentate free radical crosslinking initiator is illustrated in FIG. 1. In proceeding according to this exemplary embodiment, all polymer chains formed will be surface bound so that subsequent solvent exchange steps may in principle be eliminated.

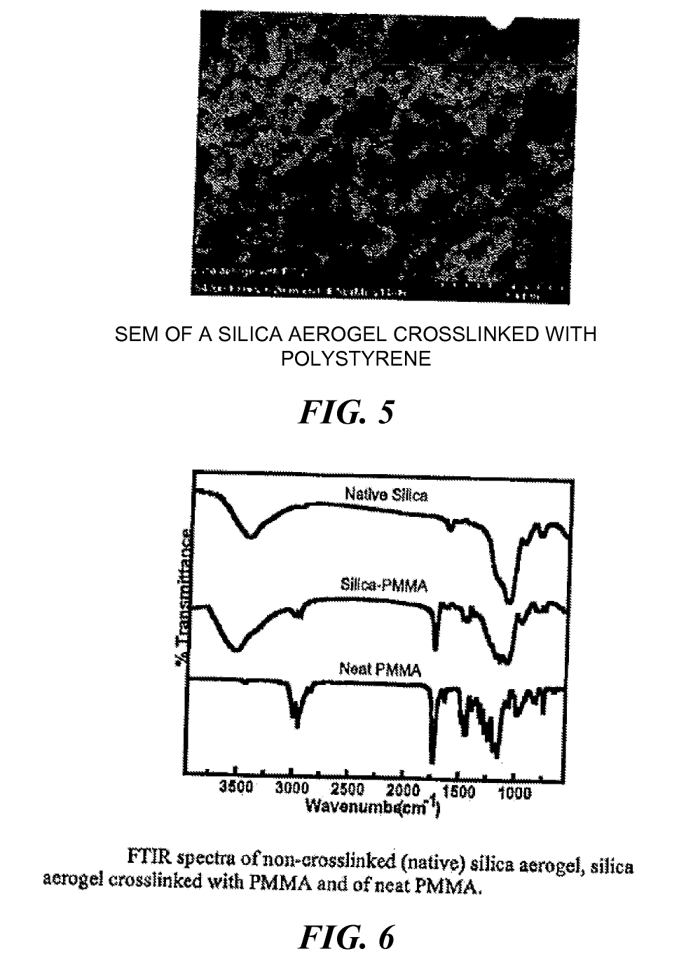

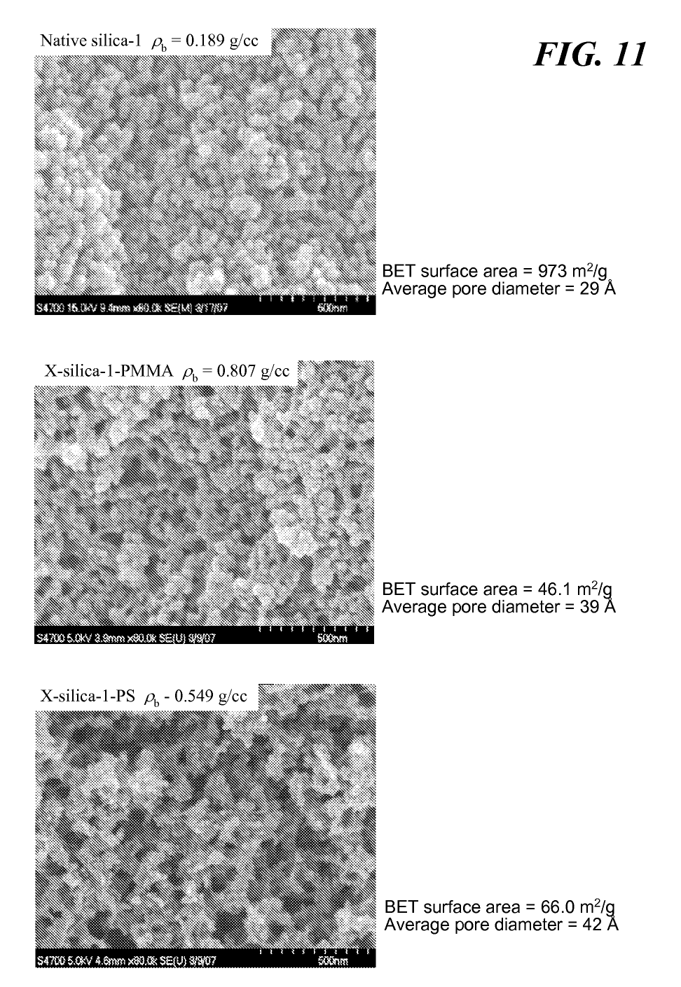

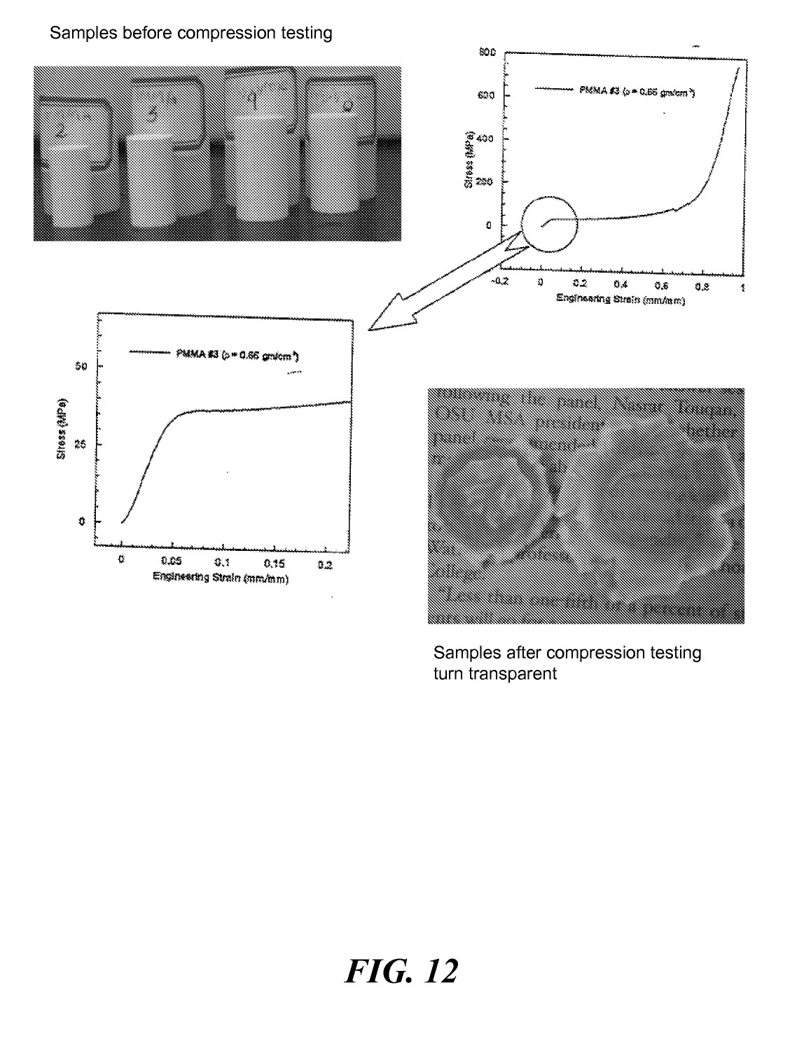

As can be seen from FIG. 1, the bidentate free radical crosslinking initiator has a backbone and two terminal ends. The terminal ends react chemically with nanoparticle surfaces and are chemically bound to them, as illustrated in FIG. 2, part A. Accordingly, the terminal ends must be reactive with the surface chemistry of the nanoparticle. Thus, since silica nanoparticles, used as exemplary embodiments herein, have active surface hydroxyl groups, the terminal ends of the crosslinking initiator should be able to react with hydroxyl groups. Upon bonding to the nanoparticles, free radical generation is initiated by homolysis, as shown in FIG. 2, part B. Thus each molecule of the bidentate crosslinking initiator generates two free radicals at the ends created by the cleavage of the molecule. In the case of the exemplary embodiment of FIG. 1, the cleavage is at the N═N bond. Free radical propagation proceeds with radicals causing polymerization of a composition capable of free radical polymerization, onto the cleaved ends of the bidentate initiator, as shown in FIG. 2, part C. Finally, the polymerization may terminate with polymer crosslinking, as shown in part D of FIG. 2. The polymer coated surfaces are shown, for example, in the SEM of FIGS. 5 and 11.

The existence of covalently bound polymer on the surface of exemplary embodiments of crosslinked silica nanoparticles was confirmed by infrared (IR) spectroscopy. FIG. 6 shows the IR spectra of neat PMMA, of a cross-linked silica aerogel with PMMA (silica-PMMA), and of a non-cross linked native silica aerogel monolith. Silica-PMMA exhibits the features corresponding to neat PMMA as well as those of non-cross linked, native silica aerogels.

Despite a bulk density increase (from about 0.189 g/cm³ to about 0.549 g/cm³ upon crosslinking with styrene and up to about 0.807 g/cm³ upon crosslinking with PMMA), microscopically (by SEM, FIG. 5) silica nanoparticles and the mesoporous space, are distinguishable consistent with a polymer grown conformally on the nanoparticle surface. BET surface areas of aerogels cross-linked in pure monomer are in the range of about 100-300 m²/g whereas the surface area in the case of cross-linked gels prepared at lower monomer concentrations are closer to those of native silica aerogels (1260 m²g⁻¹).

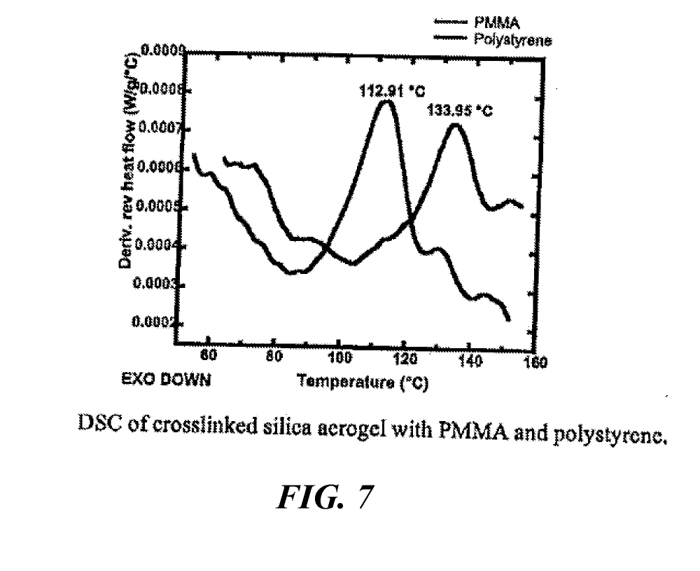

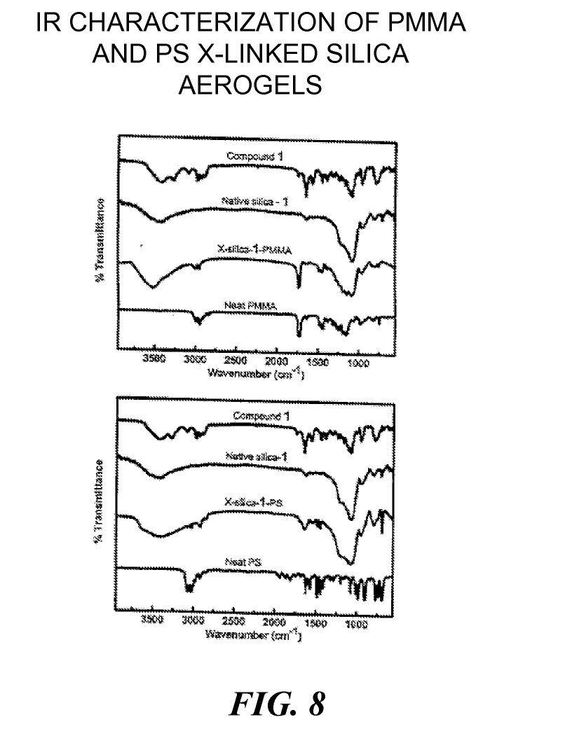

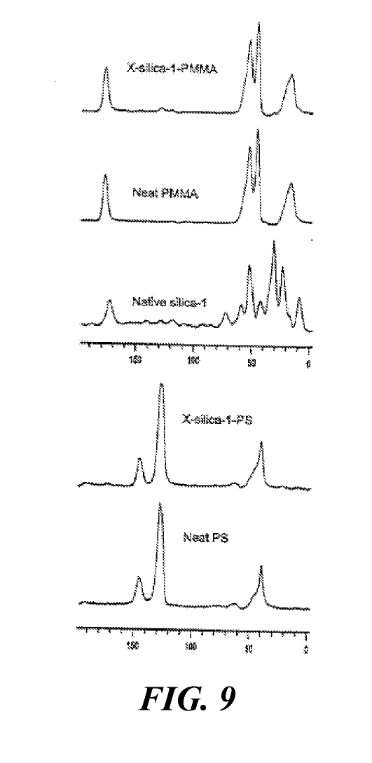

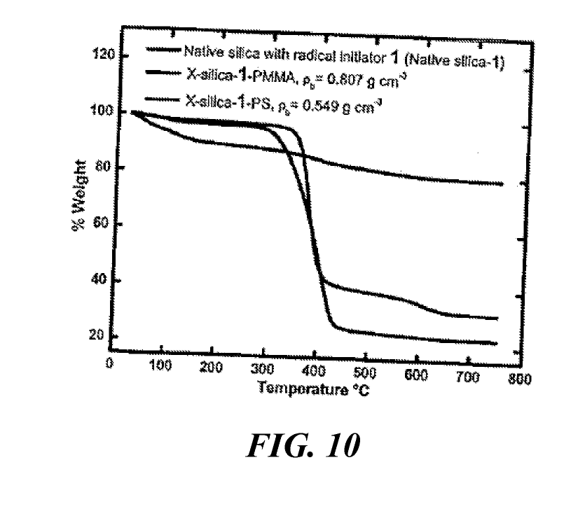

Exemplary embodiments demonstrated a shift in the glass transition temperature of surface bound polymer in comparison with neat polymer, as shown in FIG. 7. In the case of polystyrene, T_{g} was shifted from 95° C. to 112.9° C., whereas in case of PMMA, T_{g} was shifted from 105° C. to 133.95° C.

In the description and claims, the term “monolithic” as it applies to products formed from nanoparticles includes three-dimensional assemblies of nanoparticles that are reinforced with a polymer coating on at least surfaces of the nanoparticles and at least in some void space between nanoparticles to thereby form a unitary cohesive structure of predetermined shape. The cohesive structure is sized greater than powders or particulates, and may be shaped and/or sized to retain a predetermined shape, without breaking apart during processing, such as during drying. Thus, for example, the monolithic structure may be any predetermined shape such as for example, a panel, a sphere, a cylindrical shape, a complex multi-surface shape, etc. as required.

Exemplary embodiments may be usefully employed in a variety of fields. For example, taking advantage of the very high ultimate compressive strength, embodiments may be used to make superior body armor for police and other physical protection applications and in run flat tires, for example. The high mechanical strength combined with macroporosity make exemplary thin film embodiments suitable for liquid and gas filtration applications. Taking advantage of the monolithic nature and the macroporosity, exemplary embodiments may be used as media in chromatography columns. Exemplary embodiments may be used in lightweight thermal insulation, as acoustic insulation, as catalyst supports, in dielectrics in electrodes for fuel cells or other purposes, in optical sensors, in aircraft structural components, in polymer matrix composites, as hydrophobic coatings for glass, protective coatings for metals (such as Aluminum), and other surfaces, as ultrafiltration nanoporous membranes, as nanoparticle-reinforced polymer nanoparticle composites, conductive substrates using conductive polymer coatings and a host of other applications.

The following examples illustrate exemplary embodiments of the technology and do not limit the scope of the technology as disclosed herein and claimed here below.

### EXAMPLES

Preparation of Compound 1 and of silica gels incorporating Compound 1. Compound 1 is shown in FIG. 1, where n=2; m=3; n′=2; m′=3; k=1 and k′=1.

Materials: All reagents and solvents were used as received unless otherwise noted. Azobiscyanovaleric acid (ABCA), ethylchloroformate, 3-aminopropyltriethoxy silane (APTES), tetramethoxysilane (TMOS), and ammonium hydroxide were purchased from Aldrich Chemical Co. Triethylamine was obtained from Acros Chemicals and was further purified by distillation from calcium hydride Anhydrous tetrahydrofuran (THF) was made by drying over lithium aluminum hydride. Styrene and methylmethacrylate (MMA) were from Aldrich Chemical Co. and were washed with 5% sodium hydroxide solution to remove the inhibitor, and purified by distillation at reduced pressure.

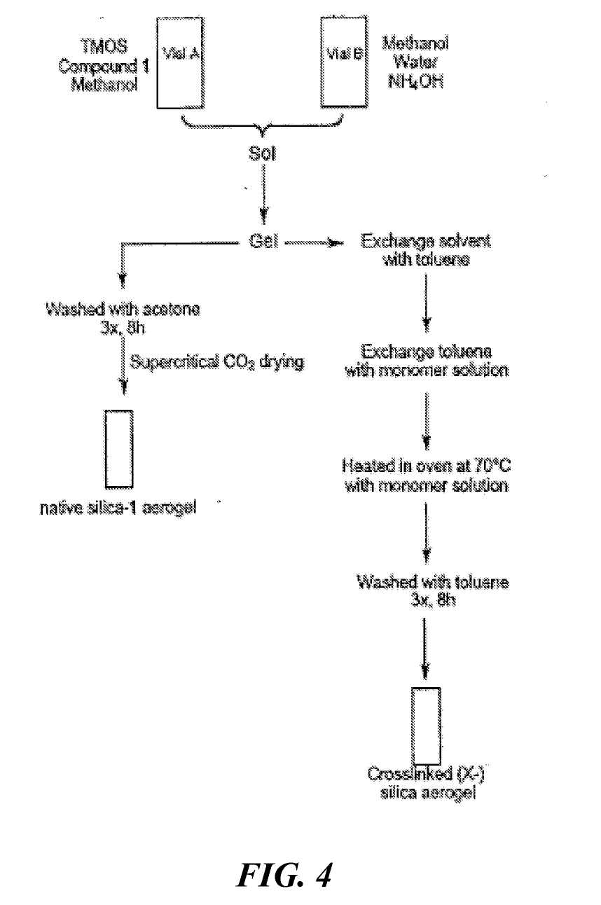

Synthesis of AIBN-silane (Compound 1): Referring now to FIG. 4, Scheme 1. Azobiscyanovaleric acid (ABCA, 19, 0.00356 mol) was dissolved in 50 ml of anhydrous THF at −50° C. in a cooled jacketed three-neck flask under dry and inert conditions (N₂). After 10 min, ethyl chloroformate (0.6822 ml, 0.00712 mol) and triethylamine (0.9918 ml, 0.00712 mol) were added with a syringe through a septum. After 20 min, APTES (1.6795 mL, 0.00712 mol) was added also with a syringe. The reaction temperature was raised to −10° C. After 24 h, the reaction mixture was allowed to reach room temperature and was filtered under nitrogen. The filtrate was concentrated under reduced pressure, followed by the addition of hexane. The precipitate was collected in a dry box under nitrogen and recrystallized from THF/hexane and dried under vacuum to give pure product which was characterized by elemental analysis, ¹³C and H NMR to confirm Compound 1. Compound 1 is sensitive to moisture and tends to self-condense. To prolong its shelf-life (up to 2-3 weeks), facilitate handling and standardize processing, Compound 1 was stored as a 0.112 M solution in anhydrous THF at 10° C.

Preparation of Silica Aerogels: the Concentration of Compound 1 was Kept Low (Mol ratio of TMOS:Compound 1=18:1) in order to reduce the initiation events and thus obtain crosslinking tethers with higher molecular weight. Under those conditions gelation occurred i 10-15 min, which is not different from the gelation of TMOS by itself. Crosslinking was carried out by first filling the mesopores of the wet gels with various toluene solutions of inhibitor-free monomers (MMA, styrene or DVB), and subsequently by heating the samples. Unreacted monomer, and polymer formed in the mesopores by possible chain transfer processes were washed off with toluene and crosslinked monoliths were dried in an autoclave with CO₂ taken out supercritically at the end.

Exemplary embodiments of polymer crosslinked aerogels that include Compound 1 are denoted as X-Si-1-polymer, where the polymer is PMMA, PS, or PDVB.

Referring now to FIG. 4, Scheme 2. The stock solution of THF (0.22 M) was allowed to warm to room temperature and an aliquot (10.9 mL, 0.0024 mol) was placed in a round bottom flask and the solvent was removed under reduced pressure. The resulting solid was dissolved by addition of methanol (0.45 mL) and TMOS (3.46 mL, 0.022 mol). This is referred to as Solution A. A second solution (Solution B) was made by mixing 4.5 ml methanol, 1.5 ml distilled water and 40 ml ammonium hydroxide. Solution “B” was added into solution “A” and the mixture was poured into polypropylenc molds (Wheaton polypropylene Omni-Vials, Part No. 225402, 1 cm in diameter). All solutions gel in 10-15 min, and newly formed wet gels were aged for 24 h at room temperature. The resulting wet gels were washed with acetone and were either dried with CO₂ taken out supercritically to obtain non-cross-linked silica aerogels, or were cross-linked with polystyrene and PMMA. For crosslinking, wet gels in acetone were further solvent-exchanged (3×, 8 h) with toluene. Meanwhile, different concentrations of styrene in toluene were prepared (10% v/v, 25% v/v, 50% v/v and 100% pure). Several silica wet-gels incorporating Compound 1 was further washed (3×, 8 h) with different styrene solutions in toluene. Similar solutions were prepared with MMA, and gels were treated similarly. Gels were heated in the last olefin wash solution at 70° C. for 8 h. Subsequently, gels were washed with fresh toluene (3×, 8 h) and dried with SCF CO₂.

One of skill in the art will readily appreciate the scope of the invention from the foregoing and the claims here below, and that the invention includes all disclosed embodiments, modifications of these that are obvious to a person of skill in the art, and the equivalents of all embodiments and modifications, as defined by law.

What is claimed is:

1. A method of coating a surface comprising the steps of:
providing a surface having hydroxyl groups;
exposing the surface to a bidentate free radical crosslinking initiator, the free radical crosslinking initiator comprising terminal ends each able to form a chemical bond with a hydroxyl group, and a backbone extending between the terminal ends, the backbone able to cleave to produce a pair of cleaved ends, each cleaved end having a free radical;
reacting a hydroxyl group of the surface with each of the terminal ends of the bidentate free radical crosslinking initiator;
cleaving the backbone of the bidentate free radical crosslinking initiator to produce a surface bound free radical at each cleaved end;
initiating polymerization of a compound by the surface bound free radicals produced; and
forming a coating of polymer on at least a portion of the surface.

2. The method of claim 1, wherein the step of exposing comprises exposing to a bidentate free radical crosslinking initiator of the formula: 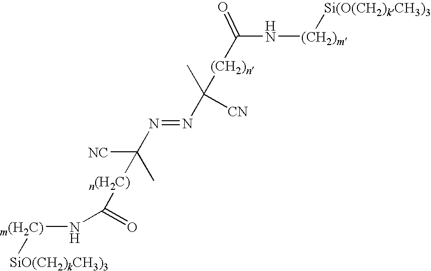
where n, m, n′, and m′ are integers greater than or equal to 1, and less than 20; and where k, k′ are integers greater than or equal to zero and less than or equal to 20.

3. The method of claim 2, wherein the step of initiating polymerization comprises initiating polymerization of a compound selected from methylmethacrylate, divinylbenzene and styrene.

4. The method of claim 1, wherein the step of initiating polymerization comprises initiating polymerization of a compound selected from olefins able to polymerize through free radical initiation.

5. The method of claim 4, wherein the step of initiating polymerization comprises initiating polymerization of a compound selected from methylmethacrylate, divinylbenzene and styrene.

6. The method of claim 1, wherein the compound surrounds the surface during the step of exposing to a bidentate free radical crosslinking initiator.

7. The method of claim 1, wherein the surface is exposed to the compound after the step of reacting.

8. The method of claim 1, wherein the step of providing a surface comprises providing at least one nanoparticle comprising silica.

9. The method of claim 8, wherein the step of initiating polymerization comprises initiating polymerization of a compound selected from methylmethacrylate and styrene; and wherein the step of exposing comprises exposing to a bidentate free radical crosslinking initiator of the formula: 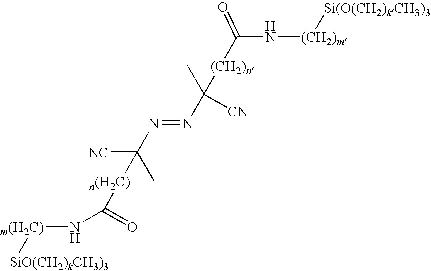
where n, m, n′, and m′ are integers greater than or equal to 1, and less than 20; and where k, k′ are integers greater than or equal to zero and less than or equal to 20.

10. A method of producing a monolithic product, the monolithic product comprising an assembly of three dimensionally dispersed, polymer coated, nanoparticles, the method comprising the steps of:
providing a gel, the gel comprising nanoparticles having surfaces comprising a surface bound bidentate free radical crosslinking initiator;
exposing the gel to compound able to polymerize;
allowing the bidentate free radical crosslinking initiator to initiate polymerization of the compound at the gel surfaces;
forming a polymer coating on at least a portion of the surfaces; and
drying into a monolithic product.

11. The method of claim 10, wherein the step of exposing comprises exposing to a compound able to polymerize selected from the olefins capable of free radical polymerization.

12. The method of claim 10, wherein the step of exposing includes exposing to an amount of the compound able to polymerize sufficient to form a conformal coating on at least a portion of nanoparticle surfaces.

13. The method of claim 10, wherein the nanoparticles are silica nanoparticles.

14. The method of claim 13, wherein the step of allowing a bidentate free radical crosslinking initiator to chemically bond comprises providing a bidentate fee radical initiator of the following formula: 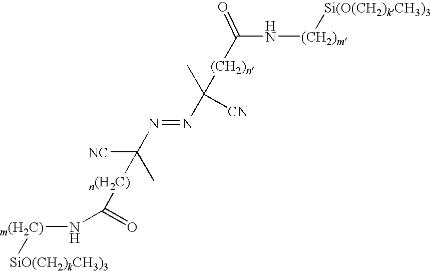
where n, m, n′, and m′ are integers greater than or equal to 1, and less than 20; and where k, k′ are integers greater than or equal to zero and less than or equal to 20.

15. A monolithic product comprising:
a three dimensional assembly of nanoparticles with void space between nanoparticles, the nanoparticles having surfaces comprising hydroxyl groups; and
a polymer coating covering at least some of the surfaces of the nanoparticles and filling at least some of the void space between nanoparticles; the polymer coating having been formed by surface initiated polymerization of constituent monomers of the polymer at locations on nanoparticle surfaces that had been modified by reaction of the hydroxyl groups on the surfaces with a bidentate free radical crosslinking initiator.

16. The monolithic product of claim 15, wherein the nanoparticles comprise silica nanoparticles.

17. The monolithic product of claim 16, monolithic product has a density less than about 0.8 g/cc.

18. The monolithic product of claim 16, wherein the monolithic product has a specific energy absorption less than about 194 J/g.

19. The monolithic product of claim 16, wherein the polymer coating comprises polymerized olefin.

20. The monolithic product of claim 16, wherein the polymer comprises methylmethacrylate, divinylbenzene or styrene.
